(19) United States
(12) Patent Application Publication
(10) Pub. No.: US 2005/0129161 A1
(43) Pub. Date: Jun. 16, 2005

(54) Apparatus and method for fusion reactor

(76) Inventor: Michel Laberge, Bowen Island (CA)

Correspondence Address: Owen W. Cramer;Smart & Biggar Fetherstonhaugh & CO, 2200 650 West Georgia Street, Vancouver, V68 4N8, CA

(21) Appl. No.: 10/507,323

(22) PCT Filed: Mar. 12, 2003
(86) PCT No.: PCT/CA03/00342

Related U.S. Application Data
(60) Provisional application No. 60/363,401, filed on Mar. 12, 2002.

(51) Int. Cl. G21B 1/00

(52) U.S. Cl. 376/144

(57) ABSTRACT

A method for inducing nuclear fusion and a reactor for inducing nuclear fusion involve positioning a bubble containing fusionable nuclei at the center of a liquid filled spherical vessel and generating a spherically symmetric positive acoustic pulse in the liquid. The acoustic pulse surrounds and converges toward the center of the vessel to compress the bubble, thereby providing energy to and inducing nuclear fusion of the atomic nuclei.

### CROSS-REFERENCE TO RELATED APPLICATIONS

This application claims priority from U.S. patent application Ser. No. 60/363,401 filed 12 Mar. 2002.

### TECHNICAL FIELD

This invention relates to nuclear fusion. Specific embodiments of the invention relate to nuclear fusion reactors and methods for generating energy by promoting nuclear fusion.

### BACKGROUND

Nuclear fusion reactions between atomic nuclei can produce large amounts of energy. Fusion reactions involve bringing together atomic nuclei against their mutual electrostatic repulsion and fusing pairs of nuclei together to make heavier nuclei. Energy is released in this process. Isotopes of light elements (i.e. elements having a relatively small number of protons) are the easiest to fuse, because the electrostatic repulsion between the nuclei of light elements is smaller than that of heavier elements.

Fusion reactions involving the nuclei of such light elements could be used to produce energy with significantly reduced radioactivity than comparable fission reactions. The easiest fusion reactions to produce include:
D+D=>³He+n+3.6 MeV; (i)
D+T=>⁴He+n+17.6 MeV; and (ii)
D+³He=>⁴He+H+18.3 MeV (iii)
where n is a neutron, H is a hydrogen atom having a single proton, D is deuterium (i.e. a hydrogen isotope with 1 proton and 1 neutron), T is tritium (i.e. a hydrogen isotope with 1 proton and 2 neutrons), and ^{x}He is a helium ion having x neutrons and protons. The number of MeV is the energy released by the fusion reaction.

Inducing nuclear fusion reactions is difficult, because of the energies required to accelerate the nuclei to speeds fast enough to overcome their mutual electrostatic repulsion and because the nuclei are so small that the chance that two passing nuclei will interact with one another in a manner which results in fusion of the nuclei is small.

The energy efficiency of a reactor is the ratio of the energy output to the energy input. In a fusion reactor, the energy output is largely determined by the number of fusion reactions that are induced in the reactor and the amount of capturable energy released. The energy input in a fusion reaction is largely determined by the amount of energy required to accelerate the nuclear reactants to thermonuclear speed and to confine the nuclear reactants in a space that allows them to interact.

In order to make a fusion reactor commercially viable, the energy output must be sufficient to offset the financial cost of manufacturing, installing and operating the reactor. The inventor is unaware of any nuclear fusion method or nuclear fusion reactor which can successfully produce energy in a controlled, reproducible and commercially viable manner.

One method for achieving controlled nuclear fusion involves heating a plasma of light nuclei to such a temperature that the thermal speed of the particles in the plasma is sufficient to produce fusion reactions between the nuclei. The plasma may be made of a deuterium-tritium mixture, for example. Containing the heated plasma while producing a sufficient number of fusion reactions to provide a commercially viable reactor has so far presented insurmountable difficulties.

Various means have been proposed to contain the plasma. Such proposals include the use of intense magnetic fields in a variety of configurations. Specific drawbacks with magnetic containment systems include: limited magnetic field strength; energy loss from plasma instabilities, heat losses and particle drift across the magnetic fields; and difficulties related to pumping sufficient amounts of energy into the plasma.

Inertial confinement techniques for implementing fusion reactors, involve quickly heating a solid pellet of fusionable material with one or more energy beams and letting the pellet explode, so that a sufficient number of fusion reactions occur before the temperature drops. Most inertial confinement experiments have been conducted using laser beams to heat the fusionable material, but ion beams and electron beams have also been proposed. A number of expensive apparatus have been developed to produce nuclear fusion reactions via inertial confinement techniques. The principal drawbacks of inertial confinement relate to costs and technological difficulties associated with generating the high-power beams used to heat the fusionable pellet. Although improvements have been made to inertial confinement devices, the inventor is currently unaware of any commercially viable inertial confinement power generation devices. No such devices have been able to produce power at a price competitive with other power sources.

Another technique proposed for producing fusion reactions involves providing a gaseous bubble of fusionable material in a liquid and then collapsing the bubble by creating an acoustic wave (i.e. a pressure wave) in the liquid. It has been suggested that upon the collapse of a bubble, fusionable material within the bubble can be compressed and heated to thermonuclear conditions (i.e. the fusionable nuclei are accelerated to sufficient speeds such that fusion reactions may occur). In Science, March 2002, “Evidence for Nuclear Emissions During Acoustic Cavitation”, Taleyarkhan et al. have proposed a basic apparatus for inducing nuclear fusion by bubble compression and claim to have detected neutrons and tritium produced during the collapse of bubbles of fusionable gas. The teachings of Taleyarkhan et al. are hereby incorporated by reference.

Flynn (U.S. Pat. No. 4,333,796), Putterman et al. (U.S. Pat. No. 5,659,173) and Pless (U.S. Pat. No. 5,968,323) have proposed techniques for collapsing gaseous bubbles of fusionable material using substantially sinusoidal acoustic waves produced by ultrasound generators.

Sinusoidal acoustic waves have periods of relatively high pressure (i.e. during the peaks of the sinusoidal pressure waves) and periods of relatively low pressure (i.e. during the troughs of the sinusoidal pressure waves). A liquid in tension will cavitate. Because of cavitation, the pressure in a liquid can not be reduced significantly below zero, even during the troughs of an applied sinusoidal acoustic wave. For this reason, the peak pressure achievable using a sinusoidal acoustic wave is limited to approximately twice the static pressure of the liquid. The static pressure of the liquid is limited by the strength of the vessel used to contain the liquid.

There exists a need for apparatus and methods for nuclear fusion reactors that ameliorate at least some of the aforementioned disadvantages of the prior art.

### SUMMARY OF THE INVENTION

In accordance with the invention, a method for inducing nuclear fusion is disclosed. The method comprises: positioning a bubble containing atomic nuclei at a location within a liquid filled vessel; generating a positive acoustic pulse in the liquid which surrounds and converges toward the bubble; and, allowing the acoustic pulse to compress the bubble to provide energy to the atomic nuclei and to thereby induce nuclear fusion therebetween.

In another aspect of the invention a nuclear fusion reactor is disclosed. The reactor comprises a vessel filled with liquid and a plurality of pistons positioned outside of the vessel. The pistons are actuable to strike an outer surface of the vessel and to thereby generate a positive acoustic pulse in the liquid. A bubble containing atomic nuclei is positionable at a location within the vessel, such that the acoustic pulse surrounds and converges toward the bubble to compress the bubble. Compression of the bubble provides energy to the atomic nuclei and thereby induces nuclear fusion therebetween.

Further features and applications of the invention are described below.

### BRIEF DESCRIPTION OF THE DRAWINGS

In drawings which depict non-limiting embodiments of the invention:

FIG. 1 is cross-sectional view of a spherical nuclear fusion reactor according to a particular embodiment of the invention;

FIG. 2 is a cross-sectional view of a spherical nuclear fusion reactor according to a second embodiment of the invention;

FIG. 3 is a diagram showing the radial distribution of pressure in an acoustic pulse provided in accordance with the invention;

FIG. 4 schematically depicts a piston control system used to control the movement of a piston in the FIG. 2 reactor; and

FIG. 5 schematically depicts a bubble tracking system and a bubble positioning system which may be used in the reactors of FIGS. 1 and 2.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

This invention provides methods and apparatus which implement a “bubble compression” fusion reactor. The invention involves creating a spherically symmetric positive acoustic pulse in a liquid which contains a spherical bubble of fusionable material. The acoustic pulse compresses and collapses the bubble to correspondingly increase the pressure and temperature of the fusionable material contained therein. At the surface of the bubble, the peak pressure of the acoustic pulse is significantly greater than that achievable using a sinusoidal or other continuously oscillating acoustic waveform. Consequently, the temperature and pressure imparted on the fusionable material is greater. This facilitates nuclear fusion reactions in the compressed fusionable material within the collapsing bubble.

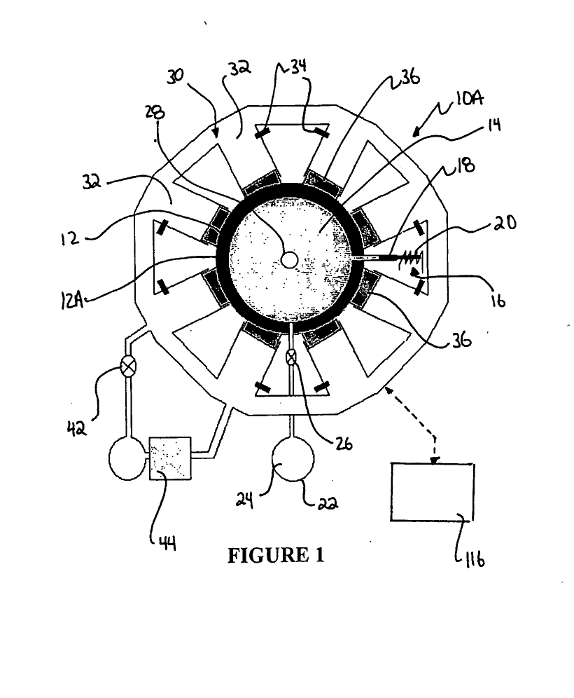

FIG. 1 depicts a nuclear fusion reactor 10A in accordance with a particular embodiment of the invention. Reactor 10A includes a spherical vessel 12 filled with a liquid 14. Spherical vessel 12 may generally be of any size. In a particular preferred embodiment, the diameter of spherical vessel 12 is in the range of about 0.6 m to about 2 m and may be approximately 1 m.

Liquid 14 may comprise any of a variety of substances that provide desirable characteristics, such as acoustic wave transfer speed, relatively low melting point, low vapour pressure at temperatures at or above the melting point of the liquid, and relatively high thermal conductivity and capacity. Liquid 14 may comprise a molten metal such as molten lithium or molten sodium, for example. As explained in greater detail below, lithium has the added advantage that it may react with neutrons produced in the fusion reaction to generate tritium which may be reused as a fusionable material. Further, lithium has a reasonably high cross-section for absorbing energy from neutrons and can serve as a shielding medium and also as a medium for converting energy of neutrons produced by fusion into heat.

Liquid 14 may contain one or more additives. The additives may include:
Isotopes which can interact within a neutron released by a fusion reaction to yield two or more lower energy neutrons. A particular example of such an isotope is ¹¹B. Those skilled in the art will appreciate that other neutron multiplying isotopes may be used;
Isotopes which absorb neutrons. The addition of such isotopes provides better shielding for the walls of reactor 10A; and,
Additives which increase a density of liquid 14 to provide a better match of acoustic impedance at the interface between liquid 14 and the wall of reactor 10A.

As shown in FIG. 1, reactor 10A may include a pressure control system 16. Pressure control system 16 functions to maintain liquid 14 at a suitable operating pressure. Pressure control system 16 may comprise any of a wide variety of pneumatic and/or hydraulic elements. In the illustrated embodiment, pressure control system 16 comprises a piston 18 driven by a solenoid 20. Solenoid 20 is preferably controlled by controller 116. Controller 116 may comprise one or more suitably programmed computers or other data processors. Controller 116 may also comprise one or more analog electronic circuits configured to perform the functions described herein. Controller 116 controls solenoid 20 to maintain a hydrostatic pressure within reactor 10A at a desired level. Pressure control system 16 may also comprise a pressure sensor (not shown) which provides a pressure feedback signal to controller 116. The pressure at which liquid 14 is maintained may vary between specific embodiments of the invention. When liquid 14 comprises lithium, a suitable pressure may be in the range of 70 bar to 200 bar and may be approximately 100 bar to 125 bar, for example.

Within practical limits, maintaining liquid 14 at a higher pressure is desirable, since higher pressure reduces the sizes of bubbles of fusionable material and therefore both increases the initial density of the bubbles and makes the shape of the bubbles more nearly perfectly spherical.

Reservoir 22 contains fusionable material 24. Preferably, fusionable material 24 is maintained in gaseous form and comprises one or more isotopes of light elements, such as deuterium, tritium, ³He or some combination thereof. It is expected that the best results can be achieved where fusionable material 24 comprises a mixture of deuterium and tritium. For example, fusionable material 24 may comprise a 50/50 mixture of deuterium and tritium.

In operation, valve 26 is controlled to release gaseous bubbles 28 of fusionable material 24 into liquid 14 through aperture 15. Preferably, valve 26 is a pulsed valve, but valve 26 may comprise any suitable valve(s) including any of a wide variety of commercially available valves. Valve 26 is preferably controlled by controller 116. Preferably, bubble 28 is spherical in shape and is released by valve 26 at the center of the bottom of vessel 12. When released into liquid 14 at the bottom of vessel 12, the buoyancy of bubble 28 causes it to rise toward the center of vessel 12.

When a spherical bubble travels through a liquid, it may be distorted in shape by forces related to viscosity and/or fluid dynamics. Preferably, bubble 28 is relatively small when first released at the bottom of vessel 12 and bubble 28 remains small when it is travelling through liquid 14. For example, the diameter of bubble 28 may be on the order of 100 μm. Because the size of bubble 28 is maintained relatively small during its movement through liquid 14, the distortions introduced to the spherical shape of bubble 28 during its travel through liquid 14 may be reduced or minimized.

In reactor 10A of FIG. 1, pressure control system 16 rapidly reduces the pressure of liquid 14 at or near the time that bubble 28 reaches the center of vessel 12. When the pressure of liquid 14 is reduced, the size of bubble 28 increases correspondingly. In the illustrated embodiment of the invention, pressure control system 16 rapidly reduces the pressure of liquid 14 by retracting piston 18. The amount of pressure reduction and the amount of increase in size of bubble 28 may vary between embodiments of the invention. In one specific example embodiment, the pressure of liquid 14 is maintained at approximately 125 bar and bubble 28 is introduced into liquid 14 with a diameter of approximately 100 μm. When bubble 28 reaches the center of vessel 12, the pressure is rapidly reduced to approximately 1 mbar, resulting in a corresponding increase in the diameter of bubble 28 to approximately 5 mm.

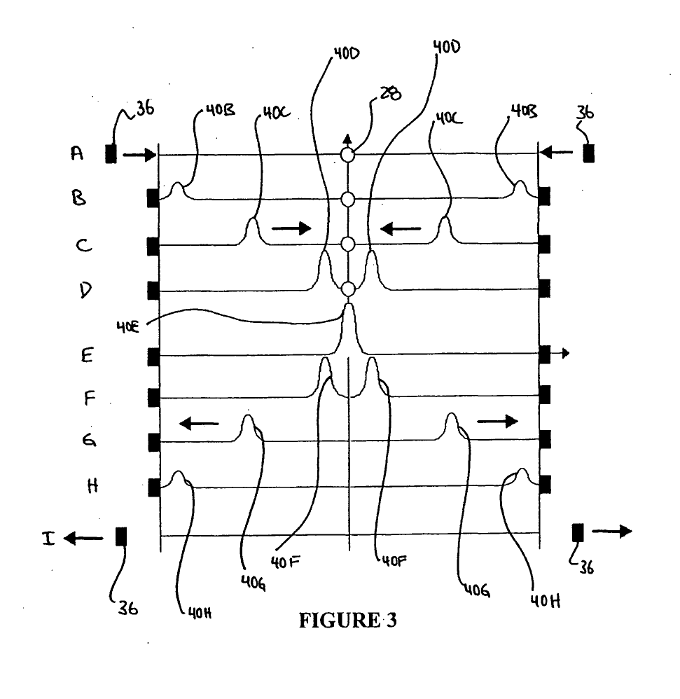

At or near the time of the decrease in pressure of liquid 14 and the corresponding increase in size of bubble 28, a high pressure, spherically symmetrical positive acoustic pulse 40 (see FIG. 3) is introduced into liquid 14. Acoustic pulse 40 may comprise a shock wave propagating in liquid 14. As shown in FIG. 3, acoustic pulse 40 converges on bubble 28.

Preferably, acoustic pulse 40 is introduced soon after bubble 28 has increased in size (i.e. when bubble 28 is still located at or near the center of vessel 12). The timing of acoustic pulse 40 is important. To obtain nuclear fusion, it is necessary to maintain a sufficiently high degree of spherical symmetry of bubble 28 as it is collapsed. If buoyant bubble 28 continues to travel through liquid 14 for a significant time after it has increased in size, there may be distortions to the shape of bubble 28. If such distortions occur before bubble 28 is collapsed by acoustic pulse 40, then they could interfere with the required symmetry.

In general, spherically symmetric acoustic pulse 40 may be introduced by a wide variety of apparatus. In reactor 10A of FIG. 1, pulse generation system 30 comprises a pneumatic-mechanical system made up of valve 42, compressor 44 and a plurality of air guns 32, each of which actuates a corresponding piston 36. Air guns 32 and pistons 36 are positioned spherically symmetrically about the outside of spherical vessel 12. Air guns 32 are loaded with compressed air (or other gas) which may be introduced by valve 42 and pressurized by compressor 44. In reactor 10A, air guns 32 are controlled by their respective latches 34. When it is desired to create spherically symmetric acoustic pulse 40, latches 34 are triggered (preferably by controller 116), causing air guns 32 to accelerate pistons 36 to high speeds. Pistons 36 then strike outer surface 12A of the wall of vessel 12.

The time at which each individual piston 36 strikes outer surface 12A of vessel 12 and the speed (i.e. kinetic energy) with which each individual piston 36 strikes outer surface 12A of vessel 12 should be as close as possible to the same (i.e. within the minimum possible tolerances). Such consistent kinetic energy and timing ensures that acoustic pulse 40 produced in liquid 14 is spherically symmetric. In reactor 10A of FIG. 1, controller 116 controls the timing and the speed of pistons 36 by controlling the time at which latches 34 are triggered. In addition, the characteristics of air guns 32 may be fine tuned. Thus, after latches 34 are triggered, pistons 36 run “open loop” (i.e. without feedback).

The impact speed (i.e. kinetic energy) with which pistons 36 strike outer surface 12A of vessel 12 is preferably made to be as high as practical without causing unacceptable damage to pistons 36 or vessel 12. When pistons 36 impact vessel 12 with a higher impact speed, resultant acoustic pulse 40 has a higher peak pressure which results in a greater potential fusion yield. If the impact speed of pistons 36 can be made to be sufficiently high, high-pressure acoustic pulse 40 can become a shock wave.

When pistons 36 strike the outside of vessel 12, spherically symmetric acoustic pulse 40 propagates through liquid 14, and converges toward bubble 28. Pistons 36 are preferably triggered at a time, such that when acoustic pulse 40 converges, it will converge at the point where bubble 28 will be located.

FIG. 3 schematically depicts a pressure profile of the propagation of acoustic pulse 40 along the radial dimension of vessel 12 at-various different points in time (A through I). At time A, bubble 28 is close to the center of vessel 12 and pulse generation system 30 triggers latches 34 to release pistons 36. In between times A and B, pistons 36 strike outer surface 12A of vessel 12 and generate spherically symmetric acoustic pulse 40.

In general, the amplitude of a spherically converging waveform increases as l/R where R is the instantaneous radius of the wave. As shown in FIG. 3 at times B, C and D, the amplitude of spherically converging, spherically symmetric acoustic pulse 40 grows as I/R. When spherically symmetric acoustic pulse 40 reaches bubble 28 (i.e at time E), its amplitude is given by:

$${P}_{peak} ∝ {P}_{o} ( \frac{{R}_{v}}{{R}_{b}} ) \qquad ( 1 )$$

where Pₒ is the initial pressure at the interior wall of vessel 12, R_{b} is the radius of bubble 28 and Rᵥ is the radius of vessel 12.

In practice, the peak pressure of acoustic pulse 40 is limited by the precision and symmetry of vessel 12, bubble 28 and acoustic pulse 40. In addition, the initial pressure Pₒ cannot be made arbitrarily high, because increasing the kinetic energy with which pistons 36 strike vessel 12 will cause damage to vessel 12, pistons 36 or both. Typically, high strength steel can handle impact pressures on the order of 10 kbar without incurring substantial structural damage. By way of example, if the symmetry of vessel 12, bubble 28 and acoustic pulse 40 are within tolerances of approximately 3%, then the ratio Rᵥ/R_{b} may be around 30. Assuming that Pₒ is approximately 10 kbar, then the peak pressure of acoustic pulse 40 at the surface of bubble 28 (i.e. time E of FIG. 3) will be approximately Pₚₑₐₖ=300 kbar. If the symmetry of vessel 12, bubble 28 and acoustic pulse 40 are within tolerances of approximately 1%, then the peak pressure of acoustic pulse 40 at the surface of bubble 28 will be approximately Pₚₑₐₖ=1 Mbar. These examples illustrate the importance of symmetry to reactors according to the invention.

Acoustic pulse 40 produced by pulse generation system 30 of reactor 10A is a positive waveform that is focused at the center of spherical vessel 12. With good symmetry, the peak pressure of acoustic pulse 40 at the surface of bubble 28 may be 100 times (or more) greater than the pressure that could be withstood by the walls of vessel 12. The peak pressure of acoustic pulse 40 represents a significant improvement over the peak pressure attainable using sinusoidal or otherwise oscillating continuous acoustic waves. As discussed above the maximum pressure that such waves can produce is limited to roughly twice the hydrostatic pressure. The hydrostatic pressure is limited to the pressure that can be withstood safely by the walls of vessel 12.

When acoustic pulse 40 converges on bubble 28, the peak pressure of pulse 40 is sufficient to cause bubble 28 to undergo a violent collapse. When this collapse occurs, the fusionable material 24 contained in bubble 28 is adiabatically compressed and heated to pressures and temperatures high enough to induce thermonuclear fusion in fusionable material 24.

When fusion reactions occur, energy is released. This energy is captured by liquid 14 in the form of heat. The amount of heat absorbed by liquid 14 depends on the nature of the fusion reaction that occurs. Preferably, any neutrons produced in the fusion reactions are absorbed in liquid 14 and do not reach the walls of vessel 12. This absorption of neutrons in liquid 14 may prevent neutron activation and degradation of vessel 12 and the other reactor components. The heat energy absorbed by liquid 14 may be extracted from liquid 14 using various energy conversion techniques that are well known in the art of energy production. Liquid 14 preferably comprises a material which acts as a moderator to slow neutrons having energies in the range of 14 MeV to thermal energies.

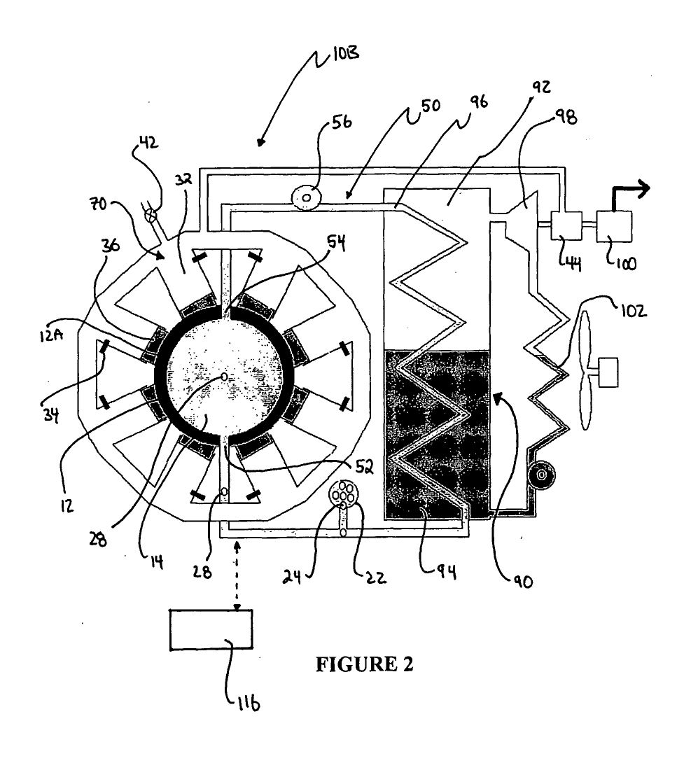

FIG. 2 depicts a fusion reactor 10B according to a second embodiment of the invention. Reactor 10B of FIG. 2 is similar to reactor 10A of FIG. 1, in that it comprises a spherical vessel 12 filled with liquid 14. However, reactor 10B of FIG. 2, comprises a fluid flow circuit 50. Fluid flow circuit 50 comprises an input port 52, through which fluid 14 flows into vessel 12, an output port 54, through which fluid 14 flows out of vessel 12, and a pump 56 for directing the flow of fluid 14. Fluid flow circuit 50 preferably comprises a flow control valve (not shown) and is controlled by controller 116.

Reservoir 22, which contains fusionable material 24 (preferably in gaseous form), is in communication with fluid flow circuit 50. A controllable valve (not shown) may be provided at the junction between reservoir 22 and fluid flow circuit 50. As with reactor 10A of FIG. 1, fusionable material 24 preferably comprises one or more light element isotopes, such as deuterium, tritium, ³He or some combination thereof.

When desired, a bubble 28 of fusionable material 24 is released from reservoir 22 arid flows through input port 52 into vessel 12. The flow of liquid 14 through vessel 12 from input port 52 to output port 54 carries bubbles 28 relatively rapidly to the center of vessel 12. In some embodiments, the pressure of liquid 14 in reactor 10B is not changed and there is no corresponding change in the size of bubble 28.

Where liquid 14 is flowing inside vessel 12, bubbles 28 containing fusionable materials-24 are preferably encapsulated in spherical capsules (i.e. micro-balloons). Such micro-balloons may be rigid to minimize any deformations to bubbles 28. The walls of the micro-balloons may be fabricated, for example, from glass, plastic or other suitable materials. Micro-balloons of this type are used, for example, in inertial confinement experiments. The micro-balloons may be injected into the liquid 14 which enters vessel 12 at port 52.

At or near the time that bubble 28 reaches the center of vessel 12, a spherically symmetric positive acoustic pulse 40 (see FIG. 3) is introduced into liquid 14. As with reactor 10A, spherically symmetric acoustic pulse 40 may be introduced by a wide variety of apparatus. In the illustrated reactor 10B of FIG. 2, acoustic pulse 40 is generated by pulse generation system 70 which includes impactors which strike outer surface 12A of vessel 12.

Pulse generation system 70 contains the same basic components as the pulse generation system 30 of reactor 10A. Such components include: valve 42, compressor 44, a plurality of air guns 32, and a corresponding plurality of pistons 36 positioned spherically symmetrically about the outside of spherical vessel 12. As described further below, the times at which air guns 32 are fired, the kinetic energies with which pistons 36 impact vessel 12 and times at which pistons 36 impact vessel 12 may be controlled to cause acoustic pulse 40 to converge at the location of bubble 28, even if bubble 28 is not perfectly centered with vessel 12.

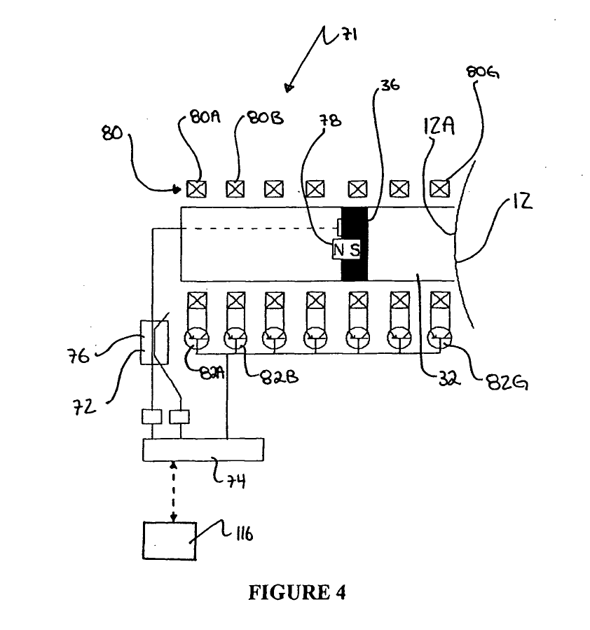

The pulse generation system 70 of reactor 10B comprises a piston control system 71 associated with each of its pistons 36 (see FIG. 4). As shown in FIG. 4, each piston control system 71 includes a position feedback mechanism 72 and a servo loop 74. Servo loops 74 may be digital and may be connected to controller 116.

Each piston control system 71 uses its associated servo loop 74 and position feedback mechanism 72 to control the movement of its corresponding piston 36. More specifically, piston control systems 71 control the speed (i.e. kinetic energy) with which each of pistons 36 strikes outer surface 12A of vessel 12 and the time at which each of pistons 36 strikes outer surface 12A of vessel 12 to determine various characteristics of acoustic pulse 40. Piston control systems 71 may control the amplitude of acoustic pulse 40 and/or the location at which acoustic pulse 40 will converge. In preferred embodiments, acoustic pulse 40 is as large as possible without causing excessive damage to pistons 36 or vessel 12 and will converge on a bubble 28 that is located at or near the center of vessel 12.

In the embodiment of FIG. 4, each position feedback mechanism 72 comprises an optical fiber interferometer 76, which measures the position of its associated piston 36. Preferably, the position measurement accuracy of optical fiber interferometer 76 is greater than 1 μm. Other types of position sensors, such as acoustic, optical and/or capacitive position sensors could be used to implement position feedback mechanism 72.

In the illustrated embodiment of FIG. 4, each piston 36 comprises a permanent magnet 78 and each associated air gun 32 is surrounded by a coil 80. Coil 80 is schematically depicted in FIG. 4 as having a plurality of loops 80A-80G. Those skilled in the art will appreciate that coil 80 may have a different number of loops. Each one of a plurality of fast transistors 82A-82G is associated with a corresponding one of loops 80A-80G. The fast transistor 82A-82G associated with each loop 80A-80G is configured to limit and thereby control the amount of current that is allowed to pass through its corresponding loop 80A-80G. The motion of piston 36 causes magnet 78 to pass through coil 80 and to induce current flow in each loop 80A-80G. Current flowing in loops 80A-80G of coil 80 generates magnetic fields which interact with the magnetic fields of magnet 78. The energy necessary to provide current in each loop 80A-80G comes from the kinetic energy of piston 36. Accordingly, fast transistors 82A-82G may be controlled by servo loop 74 to rapidly adjust the current which may be induced in loops 80A-80G and to correspondingly control the movement of piston 36.

The servo loop 74 of each piston control system 71 controls the movement of its corresponding piston 36 based, at least in part, on position information obtained from its associated position feedback mechanism 72 (i.e. optical fiber interferometer 76). For example, if it was desired to have an acoustic pulse 40 (see FIG. 3) converge precisely at the center of vessel 12 (i.e. if bubble 28 was going to be located at the center of vessel 12 when acoustic pulse 40 converges), then each servo loop 74 would control the movement of its corresponding piston 36, such that each of the plurality of spherically symmetric pistons 36 strikes outer surface 12A of vessel 12 with precisely the same speed (i.e. kinetic energy) at precisely the same time.

When pistons 36 strike outer surface 12A of vessel 12, they generate spherically symmetric acoustic pulse 40. The propagation of acoustic pulse 40 in reactor 10B is substantially similar to that in reactor 10A and is shown schematically in FIG. 3. Because pulse generation piston 36 strikes vessel 12 may be controlled to adjust the location at which acoustic pulse 40 will converge. For example, if bubble tracking system 110 predicts that bubble 28 was going to be located some distance away from the center of vessel 12 at the time that acoustic pulse 40 would converge, then piston control systems 71 may control the movement of their corresponding pistons 36, such that pistons 36 located at different positions around vessel 12 strike outer surface 12A of vessel 12 at different times. In this manner, the location at which pulse 40 converges may be moved away from the center of vessel 12 toward a predicted location of bubble 28.

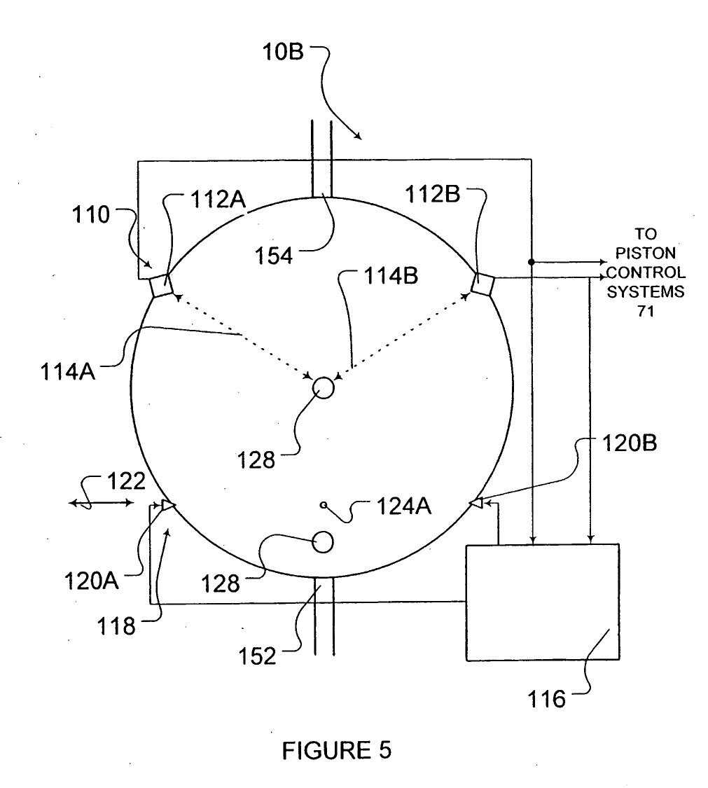

Reactor 10B may also comprise a bubble positioning system 118 (see FIG. 5) which controls the position of bubble 28 and directs bubble 28 toward the center of vessel 12. Bubble positioning system 118 may comprise a first pair of jets 120A, 120B located on opposing sides of vessel 12 along a first axis 122 and a second pair of jets 124A, 124B located on opposing sides of vessel 12 along a second spaced apart axis 126. Each of first axis 122 and second axis 126 are preferably mutually orthogonal to one another and to the axis defined by input port 52 and output port 54. For the sake of clarity in the illustration of FIG. 5, second axis 126, which is orthogonal to the page, and jet 124B are not explicitly shown.

Jets 120, 124 may cause flow of liquid 14 inwardly from the walls of vessel 12 along their respective axes 122, 126. Individual jets 120, 124 may be controlled by controller 116. Preferably, controller 116 is connected to receive measured position information relating to bubble 28 from bubble tracking system 110 and, based at least in part on the measured position of bubble 28, to determine a flow required from each of jets 120, 124 to move bubble 28 toward the center of vessel 12. As shown in FIG. 5, controller 116 may also provide the actuation signals for jets 120, 124.

When acoustic pulse 40 converges on bubble 28, the peak pressure of pulse 40 is sufficient to cause bubble 28 to undergo a violent collapse. When this collapse occurs, the fusionable material 24 contained in bubble 28 is adiabatically compressed and heated to pressures and temperatures sufficient to cause fusionable material 24 to undergo a thermonuclear fusion reaction.

When fusion reactions occur, energy is released. This energy is captured by liquid 14. This heats liquid 14. The amount of heat absorbed by liquid 14 depends on the nature of the fusion reaction that occurs. In the embodiment of FIG. 2, reactor 10B comprises an optional heat exchanger 90 which extracts heat energy from liquid 14. Any suitable heat exchanger may be used. Heat exchangers are well known in the art of energy production. Pump 56 of fluid flow circuit 50 causes liquid 14 to flow out of vessel 12 through output port 54, which leads to conduit 96 in heat exchanger 90. As heated liquid 14 flows through conduit 96, the heat from liquid 14 boils water 94, turning water 94 into pressurized steam 92. In turn, pressurized steam 92 turns turbine 98 and electric alternator 100, converting the heat energy into electrical energy. After conversion of the heat energy into electrical energy, condenser 102 completes the thermal cycle of steam 92 back into water 94. In the illustrated embodiment, turbine 98 also drives compressor 44 of pulse generation system 70.

Heat exchanger 90 is not required in all embodiments of the invention. In some embodiments, heat energy produced in liquid 14 may be used directly. Other forms of heat energy conversion equipment may be used and may convert the heat to electrical energy or into other forms of energy.

In operation, bubbles 28 (which may be encased in micro-balloons) are released into liquid 14 contained in vessel 12. Bubbles 28 may carried toward the center of vessel 12 by the flow created by fluid flow circuit 50. During their travel towards the center of vessel 12, the position of bubbles 28 may be tracked by bubble tracking system 110 and may be adjusted by bubble positioning system 118. Pulse generation system 70 creates a positive spherically symmetric acoustic pulse 40 by striking outer surface 12A of vessel 12 at a plurality of spherically symmetric locations. Pulse generation system 70 may create pulse 40 using a plurality of pistons 36 actuated by air guns 32. The kinetic energy and timing of each piston 36 may be controlled by a piston control system 71 which may use information from the bubble tracking system to control characteristics of pulse 40, such as the location of convergence of pulse 40. Acoustic pulse 40 converges on bubble 28, compressing and heating the fusionable material contained therein to thermonuclear pressures and temperatures sufficient to promote fusion reactions. The fusion reactions release heat energy which is captured in liquid 14 and which may be converted to electrical energy (or other forms of energy) by heat exchanger 90.

As will be apparent to those skilled in the art in the light of the foregoing disclosure, many alterations and modifications are possible in the practice of this invention without departing from the spirit or scope thereof. For example:
Those skilled in the art will appreciate that elements of reactor 10A (FIG. 1) may be combined with elements of reactor 10B (FIG. 2). For example, piston control systems 71 may be incorporated into pulse generation system 30 of reactor 10A to control and minimize any differences in the speed and timing of pistons 36. In other examples, fluid flow system 50 and or the heat exchanger 90 of reactor 10B may be introduced into reactor 10A.
The spherical vessels 12 of reactors incorporating the concepts of the invention may generally be of any size. As discussed above, the currently preferred vessel 12 is approximately 1 m in diameter. If vessel 12 is made larger, then the peak pressure of acoustic pulse 40 may be higher (see equation 1). However, if vessel 12 is made larger, then it may be more difficult to control the symmetry of the vessel itself, it may be more difficult to control the timing, velocity and symmetry of the associated pulse generation systems. These trade-offs related to the size of vessel 12 are a matter of engineering and the size of vessel 12 may be selected to achieve a desired result.
Reactors incorporating the concepts of the invention and, in particular pulse generation systems 30, 70, may be designed to recapture some of the energy expended to create acoustic pulse 40. After bubble 28 collapses (see FIG. 3E), waveform 40 continues to propagate and diverges radially towards the inner wall of vessel 12 as shown in FIGS. 3F, 3G and 3H. When diverging waveform 40 reaches the inner surface of the wall of vessel 12, it may accelerate pistons 36 radially outwardly and thereby recompress the air (or other gas) in air guns 32. This recompression of air guns 32 may help to improve the efficiency of reactors incorporating the invention by minimizing the energy expenditure to produce subsequent acoustic pulses 40. Typically, some energy will be lost as acoustic pulse 40 propagates through vessel 12. As such, an acoustic pulse 40 will not supply all of the energy required to reset air guns 32 to supply another acoustic pulse 40. The air (or other gas) in air guns 32 may be replenished to the desired level by compressor 44 and valve 42 which may be controlled by controller 116.
The pulse generation systems 30, 70 described above incorporate a plurality of impactors that are spherically symmetrically distributed about the outside of vessel 12. In the illustrated embodiments, the impactors comprise pistons 36. The exact number of pistons 36 may vary. Pulse generation systems 30, 70 may comprise over 50 pistons 36 and preferably comprises over 100 pistons 36. As described above, each piston 36 also has a corresponding air gun 32. The mass and speed of pistons 36 depends on the number of pistons and the total amount of kinetic energy required from the pulse generation system 30, 70. For example, a pulse generation system comprising 100 pistons, each of which weighs 0.5 kg and travels at 200 m/s when impacting vessel 12 can provide a total of 1 MJ of kinetic energy.
Pulse generation systems 30, 70 may be implemented by a variety of other techniques which generate spherically symmetric high-pressure acoustic pulses. For example, pulse generation systems 30, 70 may be implemented using electrical components, such as electrical actuators, electrical energy storage and/or electrical switches. Similarly, pulse generation systems 30, 70 may be implemented using chemical energy components, such as components based on exploding energetic compounds.
The rate at which energy is produced in fusion reactors incorporating the concepts of the invention depends on the period of time required to move successive bubbles 28 to the center of vessel 12 and to apply successive acoustic pulses 40 to collapse bubbles 28. This period may vary significantly, depending on the buoyancy of bubble 28 (reactor 10A), the flow rate of fluid flow circuit 50 (reactor 10B), and the speed of acoustic waves in liquid 14. It is expected that reactors incorporating the concepts of the invention may be designed to be pulsed at rates of over 2 Hz and, preferably, at rates of 4 Hz or higher.
The rate of fluid flow through circuit 50 of reactor 10B depends on a number of factors, including the rate of heat energy production in reactor 10B and the upper limit of the speed at which bubble 28 may be transported through liquid 14 without distorting the spherical shape of bubble 28. A stable flow pattern is preferably maintained. In a preferred embodiment, a toroidal flow pattern is maintained, wherein liquid 14 rises along a central axis of reactor 10B and travels downwardly around the circumference of reactor 10B. Under such a toroidal flow pattern, the currently preferred flow rate of fluid flow circuit 50 is approximately 0.25 m³/s for a vessel 12 having a 1 m diameter and a pulse rate of 4 Hz. As more heat energy is produced, the flow rate of circuit 50 may be increased to extract the heat energy from liquid 14 in heat exchanger 90. However, the flow rate of circuit 50 may not be increased indefinitely, because higher flow rates tend to distort the shape of bubbles 28, reducing the fusion yield.
When the fusion reaction produces a fast neutron and liquid 14 is lithium, then there is a possibility that the liquid lithium will react with the fast neutron to produce tritium (⁶Li+n=>T+⁴He 4.6 MeV). This tritium may be extracted and re-used by the system as fuel (i.e. fusionable material 24).
As shown in FIG. 2, compressor 44 may use some of the energy produced by reactor 10B to replace the air (or other gas) in the air guns 32 of pulse generation system 70. Compressor 44 may be driven by turbine 98. In alternative-embodiments, the pressurized steam 92 produced in heat exchanger 90 may be used directly to power air guns 32 of pulse generation system 70.
Bubble tracking system 110 may comprise a larger number of position detectors to improve the accuracy of the measured position of bubble 28. Bubble tracking system 110 of FIG. 5 may include more than three ultrasonic position detectors 112.
Bubble positioning system 118 may comprise more than two pairs of jets 120, 124. Those skilled in the art will appreciate that additional jets (not shown) may be used to improve the accuracy with which bubble positioning system 118 may position bubble 28.

Accordingly, the scope of the invention is to be construed in accordance with the substance defined by the following claims.

1-57. (canceled)

58. A method for initiating nuclear fusion in a fusionable material, the method comprising the steps of:
introducing a quantity of the fusionable material into a liquid filled vessel;
determining the location of the fusionable material in the liquid filled vessel; and
directing an acoustic pulse towards the determined location of the fusionable material such that the acoustic pulse symmetrically converges on the fusionable material thus increasing the temperature and pressure thereof to a sufficient extent to initiate nuclear fusion in the fusionable material.

59. The method according to claim 58, wherein the acoustic pulse is directed to a fixed location in the vessel and the step of determining the location of the fusionable material comprises determining whether the fusionable material is within a pre-determined distance from the fixed location before initiating the acoustic pulse.

60. The method according to claim 59, comprising the further step of actively directing the fusionable material towards the fixed location.

61. The method according to claim 58, wherein the acoustic pulse comprises a plurality of independently generated pulses and directing the acoustic pulse comprises timing the initiation of the independently generated pulses to produce a composite pulse that converges on the determined location of the fusionable material.

62. The method according to claim 58, wherein the quantity of fusionable material is buoyant in the liquid and the fusionable material is introduced into the liquid at a lower end of the vessel and allowed to rise under hydrostatic forces to a position proximate the center of the vessel.

63. The method according to claim 62, wherein the fusionable material is introduced at a lower end of the vessel and the acoustic pulse is directed towards the fusionable material when the fusionable material has risen to a location proximate the center of the vessel.

64. The method according to claim 62, further comprising the step of introducing a flow in the liquid, the flow for directing the fusionable material towards a desired location in the vessel.

65. The method according to claim 64, wherein the flow direction is aligned with the direction of the hydrostatic forces.

66. The method according to claim 58, wherein determining the location of the fusionable material comprises determining a first location for the fusionable material and using the first location to predict a future location of the fusionable material.

67. The method according to claim 58, wherein the fusionable material is introduced in the form of a gaseous bubble.

68. The method according to claim 67, wherein the gaseous bubble is very small when it is introduced and the bubble is allowed to expand by rapidly reducing the pressure in the vessel immediately prior to directing the acoustic pulse at the bubble of fusionable material.

69. The method according to claim 58, wherein the fusionable material is contained in a micro-balloon.

70. The method according to claim 58, wherein the acoustic pulse is generated by a plurality of peripherally located pistons striking the vessel.

71. The method according to claim 70, comprising controlling each of the pistons striking the vessel such that the generated acoustic pulse converges to a desired location in the vessel.

72. The method according to claim 70, wherein a residual acoustic pulse energy remaining after the fusion has been initiated is used to at least partially recompress the pistons.

73. The method according to claim 70, wherein the fusion produces heat and at least a portion of the heat is used to produce steam, at least a portion of the steam being used to re-compress the pistons.

74. The method according to claim 73, wherein the portion of the steam not used to recompress the pistons is used to drive a steam turbine for converting the heat energy into electrical energy.

75. A nuclear fusion reactor comprising:
a vessel for containing a liquid;
an aperture for introducing a quantity of fusionable material into the vessel;
a fusionable material tracking system for determining the location of the fusionable material in the vessel; and
a pulse generation system for generating an acoustic pulse, the pulse being directed toward the determined location of the fusionable material such that the acoustic pulse symmetrically converges on the fusionable material thus increasing the temperature and pressure thereof to a sufficient extent to initiate nuclear fusion in the fusionable material.

76. The reactor according to claim 75, wherein the tracking system comprises one or more ultrasonic sensors for measuring the location of the fusionable material.

77. The reactor according to claim 75, further comprising a fusionable material positioning system for directing the fusionable material to a desired location in the vessel.

78. The reactor according to claim 77, wherein the positioning system comprises a plurality of peripherally located jets oriented towards the center of the vessel.

79. The reactor according to claim 75, wherein the pulse generation system comprises a plurality of independent pulse generators and the tracking system provides a plurality of signals for timing the initiation of the independent pulse generators such that the pulse is directed toward the determined location of the fusionable material.

80. The reactor according to claim 75, wherein the pulse generation system comprises a plurality of peripherally located pistons disposed to strike the outside surface of the vessel thus generating an acoustic pulse in the liquid.

81. The reactor according to claim 80, wherein the vessel is spherically shaped and the plurality of pistons are located to strike the vessel at a plurality of spherically symmetric locations.

82. The reactor according to claim 81, wherein each of the plurality of pistons is sized and actuated to strike the vessel with a substantially identical kinetic energy.

83. The reactor according to claim 80, comprising a position sensor associated with each piston for providing a feedback signal for controlling the impact of each piston on the vessel.

84. The reactor according to claim 83, comprising a controller configured to synchronize the impact of the pistons such that the acoustic pulse converges on a desired location in the vessel.

85. The reactor according to claim 80, comprising a heat exchanger in fluid communication with the vessel for extracting at least a portion of the heat energy generated by the fusion.
